(19) United States
(12) Patent Application Publication
(10) Pub. No.: US 2009/0264566 A1
(43) Pub. Date: Oct. 22, 2009

(54) Stabiliser composition made from liquid and solid uv-absorbers

(75) Inventors: Simon Schambony, Ludwigshafen (DE); Hubert Trauth, Dudenhofen (DE); Alban Glaser, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF AKTIENGESELLSCHAFT, LUDWIGSHAFEN (DE)

(21) Appl. No.: 11/658,884

(22) PCT Filed: Jul. 29, 2005
(86) PCT No.: PCT/EP05/08271

§ 371 Date: Jan. 30, 2007

(30) Foreign Application Priority Data
Jul. 30, 2004 (DE) 102004036965.8

(51) Int. Cl. C08K 5/315; F21V 9/06

(52) U.S. Cl. 524/208; 252/589

(57) ABSTRACT

The present invention relates to a stabilizer composition (S), composed of (i) at least one UV absorber solid under standard conditions, selected from the group of the diphenylcyanoacrylates with a molar mass of at least 500 g/mol and (ii) at least one UV absorber which is liquid at 50° C. and standard pressure. The present invention also relates to a polymer composition, comprising this stabilizer composition (S), and to a process for preparation of polyisocyanate polyaddition products via reaction of polyisocyanates with compounds reactive toward isocyanates, where the reaction takes place in the presence of this stabilizer composition (S).

The present invention relates to a stabilizer composition which is composed of at least one UV absorber solid under standard conditions, selected from the group of the diphenylcyanoacrylates with a molar mass of at least 500 g/mol and at least one UV absorber which is liquid at 50° C. and standard pressure, and to its use for stabilization of polymer compositions. The present invention also relates to a process for preparation of polyisocyanate polyaddition products via reaction of polyisocyanates with polyfunctional compounds reactive toward isocyanates, where the reaction takes place in the presence of this stabilizer composition.

The mechanical, chemical, and/or aesthetic properties of non-living organic material, in particular of plastics, are known to be impaired via exposure to light, in particular to the ultraviolet radiation (UV) content of daylight. Plastics can be stabilized using at least one UV absorber, in order to prevent embrittlement, fading of color, or yellowing due to the UV content of sunlight. A large number of various solid and liquid compounds are known to be suitable UV absorbers, examples being found in the group of the benzotriazoles, diphenylcyanoacrylates, cinnamic esters, hydroxybenzophenones, or hydroxyphenyltriazines.

It is known that solid UV absorbers, e.g. 2-cyanoacrylates with high molecular weight, can be used to stabilize organic materials, such as plastics. It has been found hitherto that incorporation and homogeneous dispersion of solid UV absorbers in plastic molding compositions is difficult. These disadvantages are generally not possessed by liquid UV absorbers.

However, liquid UV absorbers have the practical disadvantage of relatively high volatility. Because, furthermore, they have only limited compatibility with many plastics they have a tendency to migrate, particularly on exposure to heat, and exhibit exudation effects. This leads to loss of stabilization and to undesired release of the UV absorber. The substances discharged from the plastic are, by way of example, deposited in the form of a mist-like deposit on the inside of windshields. This effect is termed “fogging”. The deposit impairs vision, in particular in direct sunlight or during the night, as a result of the dazzling effect of headlamps of approaching vehicles. There is therefore a need for UV stabilizer compositions which avoid the abovementioned disadvantages.

WO 96/15102 describes high-molecular-weight 2-cyanoacrylates which are suitable, inter alia, for stabilization of plastic. Very general mention, without evidence via any example, is also made of a possible combination of high-molecular-weight 2-cyanoacrylates with other light stabilizers, such as derivatives of α-cyanocinnamic acid, 2-hydroxybenzophenones, and 2-(2′-hydroxyphenyl)benzotriazoles.

U.S. Pat. No. 6,297,300 describes carbonate polymers which comprise, as light stabilizer composition, at least two UV light stabilizers selected from different groups, each with a molar mass of at least 400 g/mol. Suitable groups are cyanoacrylates, hydroxyphenylbenzotriazoles, and hydroxyphenyltriazines. 1,3-bis[(2′-Cyano-3′,3′-diphenylacryloyl)oxy]-2,2-bis{[2′-cyano-3′,3′-diphenylacryloyl)oxy]methyl}propane is mentioned as a suitable high-molecular-weight cyanoacrylate.

WO 01/57125 describes a candle wax stabilized with benzotriazoles. Use can also be made of other UV stabilizers, such as s-triazines, benzoates, α-cyanoacrylates, benzophenones, malonates, oxanilides, and salicylates.

U.S. Pat. No. 5,821,292 describes the use of 3-arylacrylates as light stabilizers. These may be used in combination with other light stabilizers, such as 2-(2-hydroxyphenyl)-benzotriazoles, 2-hydroxybenzophenones, aryl esters of hydroxybenzoic acids, derivatives of α-cyanocinnamic acid, benzimidazolecarboxanilides, nickel compounds, and oxanilides. They are used, inter alia, for stabilization of polyurethanes.

EP 1 323 743 describes a resin composition which comprises a mixture of UV absorbers, which encompasses a cyanoacrylate and a benzotriazole.

EP 0 992 533 describes polyisocyanate polyaddition products which contain a covalently bonded dye and comprise at least one UV absorber selected from the group of the benzotriazoles, cinnamic esters, diphenylcyanoacrylates, and benzophenones, at least one antioxidant, and at least one free-radical scavenger. One preferred UV absorber inter alia is 2-ethylhexyl p-methoxycinnamate.

DE 100 58 290 describes the use of light stabilizers selected from cyanoacrylates, diphenylbutadienes, benzophenones, and cinhamic esters for stabilization of polyolefins. There are no examples of a combination of two or more light stabilizers.

U.S. Pat. No. 4,935,275 discloses a stabilizer composition for stabilization of polyurethanes, this being a ternary system composed of a sterically hindered amine, a C₂-C₈-alkyl 2-cyano-3,3-diphenylacrylate, such as 2-ethylhexyl 2-cyano-3,3-diphenylacrylate, and a sterically hindered phenol.

It is an object of the present invention to provide a novel stabilizer composition with good practical properties. In particular, the composition is to have a high level of protective action with respect to damaging exposure to light, and to take a form which can easily be incorporated into the material to be stabilized and can be homogeneously dispersed. The intention here is to avoid the disadvantages specifically mentioned above, in particular fogging derived from the plastic. The stabilizer composition is to have particularly effective suitability for stabilization of polyisocyanate polyadditon products and polyvinyl chloride.

Surprisingly, the object is achieved via a stabilizer composition (S), composed of:
(i) at least one UV absorber solid under standard conditions, selected from the group of the diphenylcyanoacrylates with a molar mass of at least 500 g/mol and
(ii) at least one UV absorber which is liquid at 50° C. and standard pressure.

The present invention therefore provides a stabilizer composition (S) as defined above and its use in a polymer composition which comprises at least one polymer preferably selected from polyesters, polycarbonates, polyamides, polyolefins, polyvinyl acetals, polystyrene, copolymers of styrene or α-methylstyrene with dienes and/or with acrylic derivates, or from halogen-containing polymers, polyisocyanate polyaddition products, and mixtures of these.

The present invention also provides a process for production of polyisocyanate polyaddition products via reaction of polyisocyanates with compounds reactive toward isocyanate groups, where the reaction takes places in the presence of the stabilizer composition (S) as defined above.

For the purposes of the present invention, the expression “polyisocyanate polyaddition product” means oligomeric and polymeric compounds which are obtained during the reaction of di- or polyfunctional isocyanates with compounds which have at least two groups reactive toward NCO groups. The resultant oligomeric and polymeric compounds may therefore, as determined by the starting materials and by the reaction management, contain polyurethane structures and, if appropriate, polyisocyanurate structures, polyurea structures, polyallophanate structures, and polybiuret structures.

For the purposes of the present invention, the expression “standard conditions” means a standard temperature of 25° C.=298.15 K and a standard pressure of 101 325 Pa.

For the purposes of the present invention, the expression “liquid” means rheological properties which extend from low-viscosity liquid by way of pasty/creamy to gel-like. “Gel-like consistency” is exhibited by compounds or compositions whose viscosity is higher than that of a liquid and which are self-supporting, i.e. retain a shape that they have been given without any shape-stabilizing encapsulation. However, unlike solid compounds or compositions, gel-like compounds or compositions can be deformed by using shear forces. For the purposes of the present invention, the expression “flowable” can also be used as a synonym for the expression “liquid”.

For clarification purposes in the context of the present invention, the term “alkyl” means straight-chain or branched hydrocarbon radicals. These are preferably straight-chain or branched C₁-C₂₀-alkyl and particularly preferably C₁-C₁₂-alkyl groups. Particular examples of alkyl groups are methyl, ethyl, propyl, isopropyl, n-butyl, isobutyl, sec-butyl, tert-butyl, n-pentyl, 2-pentyl, 3-pentyl, 2-methylbutyl, 3-methylbutyl, 1,2-dimethylpropyl, 1,1-dimethylpropyl, 2,2-dimethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 4-heptyl, n-octyl, 2-ethylhexyl, 2-propylheptyl, 1,1,3,3-tetramethylbutyl, nonyl, decyl, n-undecyl, n-dodecyl, n-tridecyl, iso-tridecyl, n-tetradecyl, n-hexadecyl, n-octadecyl, and n-eicosyl.

The term alkyl also comprises alkyl whose carbon chain may have interruption by one or more non-adjacent groups selected from —O—, —S—, —NR¹⁰— (where R¹⁰ is hydrogen or C₁-C₄-alkyl), —CO—, and/or —SO₂—, i.e. the termini of the alkyl group are formed by carbon atoms.

The above statements also apply to all of the alkyl moieties in alkoxy, alkoxycarbonyl, cycloalkoxycarbonyl, alkylamino, and dialkylamino.

For the purposes of the present invention, the term “alkenyl” comprises straight-chain and branched alkenyl groups which, depending on the chain length, may bear one or more double bonds. Preference is given to C₂-C₂₀-alkenyl groups, and particular preference is given to C₂-C₁₀-alkenyl groups, such as vinyl, allyl, or methallyl. The term “alkenyl” also comprises substituted alkenyl groups which, by way of example, may bear 1, 2, 3, 4, or 5 substituents. Examples of suitable substituents are cycloalkyl, heterocycloalkyl, aryl, heteroaryl, cyano, halogen, amino, mono- or di(C₁-C₂₀-alkyl)amino.

For the purposes of the present invention, the term “cycloalkyl” comprises unsubstituted or substituted single- or multiring cycloalkyl groups, preferably C₃-C₁₀-cycloalkyl groups, such as cyclopropyl, cyclobutyl, cyclopentyl, cyclohexyl, cycloheptyl, cyclooctyl, cyclononyl, cyclodecyl, hydrindanyl, decalinyl, bicyclo[2.2.1]hept-1-yl, bicyclo[2.2.1]hept-2-yl, bicyclo[2.2.1]hept-7-yl, bicyclo[2.2.2]oct-1-yl, bicyclo[2.2.2]oct-2-yl, bicyclo[3.3.0]octyl, and bicyclo[4.4.0]decyl.

Substituted cycloalkyl groups may bear one or more, for example one, two, three, four, or five, substituents selected from C₁-C₂₀-alkyl and C₁-C₆-alkoxy.

For the purposes of the present invention, the term “cycloalkenyl” comprises unsubstituted or substituted single- or multiring cycloalkenyl groups, preferably C₃-C₁₀-cycloalkenyl groups, such as cyclopropenyl, cyclobutenyl, cyclopentenyl, cyclohexenyl, cycloheptenyl, cyclooctenyl, cyclononenyl, cyclodecenyl, indenyl, or tetralinyl. The cycloalkenyl groups may contain one or more double bonds, for example 1, 2, 3, or 4 double bonds. Substituted cycloalkenyl groups may bear one or more substituents, for example, one, two, three, four, or five substituents, selected from C₁-C₂₀-alkyl and C₁-C₆-alkoxy.

For the purposes of the present invention, the term “aryl” comprises single- or multiring aromatic hydrocarbon radicals, such as aromatic hydrocarbon radicals having one, two, or three rings, and having no substituents or having substituents. A substituted aryl group may generally have 1, 2, 3, 4, or 5 substituents, preferably 1, 2, or 3 substituents, selected from C₁-C₂₀-alkyl and C₁-C₆-alkoxy. The term “aryl” preferably means phenyl, tolyl, xylyl, mesityl, duryl, naphthyl, fluorenyl, anthracenyl, phenanthrenyl, or naphthyl, particularly preferably phenyl, or naphthyl.

Examples of aryl having no substituents or bearing one or more radicals selected independently of one another from C₁-C₂₀-alkyl and C₁-C₆-alkoxy are 2-, 3- and 4-methylphenyl, 2,4-, 2,5-, 3,5-, and 2,6-dimethylphenyl, 2,4,6-trimethylphenyl, 2-, 3-, and 4-ethylphenyl, 2,4-, 2,5-, 3,5-, and 2,6-diethylphenyl, 2,4,6-triethylphenyl, 2-, 3-, and 4-propylphenyl, 2,4-, 2,5-, 3,5-, and 2,6-dipropylphenyl, 2,4,6-tripropylphenyl, 2-, 3-, and 4-isopropylphenyl, 2,4-, 2,5-, 3,5-, and 2,6-diisopropylphenyl, 2,4,6-triisopropylphenyl, 2-, 3-, and 4-butylphenyl, 2,4-, 2,5-, 3,5-, and 2,6-dibutylphenyl, 2,4,6-tributylphenyl, 2-, 3-, and 4-isobutylphenyl, 2,4-, 2,5-, 3,5-, and 2,6-diisobutylphenyl, 2,4,6-triisobutylphenyl, 2-, 3-, and 4-sec-butylphenyl, 2,4-, 2,5-, 3,5-, and 2,6-di-sec-butylphenyl, 2,4,6-tri-sec-butylphenyl, 2-, 3-, and 4-tert-butylphenyl, 2,4-, 2,5-, 3,5-, and 2,6-di-tert-butylphenyl and 2,4,6-tri-tert-butylphenyl; 2-, 3-, and 4-methoxyphenyl, 2,4-, 2,5-, 3,5-, and 2,6-dimethoxyphenyl, 2,4,6-trimethoxyphenyl, 2-, 3-, and 4-ethoxyphenyl, 2,4-, 2,5-, 3,5-, and 2,6-diethoxyphenyl, 2,4,6-triethoxyphenyl, 2-, 3-, and 4-propoxyphenyl, 2,4-, 2,5-, 3,5-, and 2,6-dipropoxyphenyl, 2-, 3-, and 4-isopropoxyphenyl, 2,4-, 2,5-, 3,5-, and 2,6-diisopropoxyphenyl, and 2-, 3-, and 4-butoxyphenyl.

For the purposes of the present invention, the term “heterocycloalkyl” comprises non-aromatic, unsaturated or fully saturated, cycloaliphatic groups generally having from 5 to 8 ring atoms, preferably 5 or 6 ring atoms, in which 1, 2, or 3 of the ring carbon atoms have been replaced by heteroatoms selected from oxygen, nitrogen, sulfur, and an —NR¹⁰ group (where R¹⁰ is as defined above), having no substituents or having one or more substituents, for example 1, 2, 3, 4, 5, or 6 C₁-C₂₀-alkyl and C₁-C₆-alkoxy substituents. By way of example of these heterocycloaliphatic groups, mention may be made of pyrrolidinyl, piperidinyl, 2,2,6,6-tetramethylpiperidinyl, imidazolidinyl, pyrazolidinyl, oxazolidinyl, morpholidinyl, thiazolidinyl, isothiazolidinyl, isoxazolidinyl, piperazinyl, tetrahydrothiophenyl, dihydrothienyl, tetrahydrofuranyl, dihydrofuranyl, tetrahydropyranyl, isoxazolinyl, oxazolinyl, and dioxanyl.

For the purposes of the present invention, the term “heteroaryl” comprises unsubstituted or substituted, heteroaromatic, single- or multiring groups generally having from 5 to 14 ring atoms, preferably 5 or 6 ring atoms, in which 1, 2, or 3 of the ring carbon atoms have been replaced by heteroatoms selected from oxygen, nitrogen, sulfur and a —NR¹⁰ group (where R¹⁰ is as defined above), having no substituents or having one ore more substituents, for example 1, 2, 3, 4, 5, or 6 C₁-C₂₀-alkyl and C₁-C₆-alkoxy substituents. By way of example of these heteroaryl groups, mention may be made of the following groups: furyl, thienyl, oxazolyl, isoxazolyl, thiazolyl, isothiazolyl, benzofuranyl, benzothiophenyl, pyridyl, quinolinyl, acridinyl, pyridazinyl, pyrimidinyl, pyrazinyl, pyrryl, imidazolyl, pyrazolyl, indolyl, purinyl, indazolyl, benzotriazolyl, 1,2,3-triazolyl, 1,2,4-triazolyl, and carbazolyl, and substituted heterocycloaromatic groups here may generally bear 1, 2, or 3 substituents. The substituents are selected from C₁-C₆-alkyl and C₁-C₆-alkoxy.

For the purposes of the present invention, the term “acyl” comprises alkanoyl, hetaroyl, and aroyl groups generally having from 1 to 11, preferably from 2 to 8, carbon atoms, for example the formyl, acetyl, propionyl, butyryl, pentanoyl, hexanoyl, heptanoyl, 2-ethylhexanoyl, 2-propylheptanoyl, benzoyl, or naphthoyl group.

The expression “halogen” comprises fluorine, chlorine, bromine, and iodine, preferably chlorine and bromine.

The inventive stabilizer composition (S) is preferably a viscous liquid under standard conditions and can therefore easily be incorporated into the material to be stabilized, and homogeneously dispersed. The inventive stabilizer composition (S) is preferably a liquid which is viscous under standard conditions and whose kinematic viscosity is in the range from 10⁻⁶ m²s⁻¹ to about 200,000 mm²s⁻¹, in particular from 10 mm²s⁻¹ to 150,000 mm²s⁻¹, very particularly preferably from 1000 mm²s⁻¹ to 120,000 mm²s⁻¹, for example from 50,000 to 110,000 mm²s⁻¹, determined using a capillary viscometer to DIN 51562-1 at 20° C. The inventive stabilizer composition (S) which is liquid under standard conditions may be a solution or dispersion. Solutions are preferred.

A suitable component i) is in principle any of the diphenylcyanoacrylates whose molar mass is at least 500 g/mol. In one preferred embodiment of the present invention, component i) comprises only those compounds whose molar mass is at least 650 g/mol, in particular at least 800 g/mol, and very particularly preferably at least 1000 g/mol.

Preferred UV absorbers suitable as component i) of the inventive stabilizer composition (S) have the general formula (I):

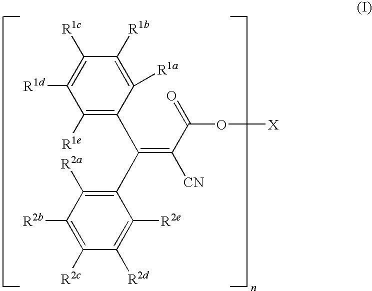

where

R^{1a}, R^{1b}, R^{1c}, R^{1d}, R^{1e}, R^{2a}, R^{2b}, R^{2c}, R^{2d}, and R^{2e} independently of the others, is hydrogen, alkyl, alkenyl, halogen, cyano, nitro, amino, monoalkylamino, dialkylamino, hydroxy, acyl, acyloxy, alkoxy, alkoxycarbonyl, cycloalkyl, cycloalkoxycarbonyl, cycloalkenyl, aryl, heteroaryl, or heterocycloalkyl;

n is a whole number from 3 to 10; and

X is an n-valent aliphatic or cycloaliphatic radical having from 3 to 20 carbon atoms, where a cycloaliphatic radical may also have interruption via from 1 to 2, and an aliphatic radical via 1, 2, 3, 4, 5, 6, 7, 8, or 9, non-adjacent oxygen atoms, sulfur atoms, imino groups, or C₁-C₄-alkylimino groups.

If at least one of the radicals R^{1a}, R^{1b}, R^{1c}, R^{1d}, R^{1e}, R^{2a}, R^{2b}, R^{2c}, R^{2d}, and R^{2e} is alkyl, it is preferably C₁-C₂₀-alkyl. Alkenyl is preferably C₂-C₁₀-alkenyl. Halogen is preferably chlorine or brome. Monoalkylamino is preferably mono(C₁-C₄-alkyl)amino. Dialkylamino is preferably di(C₁-C₄-alkyl)amino. Acyl is preferably C₁-C₈-acyl. Acyloxy is preferably C₁-C₈-acyloxy. Alkoxy is preferably C₁-C₁₈-alkoxy. Alkoxycarbonyl is preferably C₁-C₁₂-alkoxycarbonyl. Cycloalkyl is preferably C₃-C₁₀-cycloalkyl, bearing no substituents or having one, two, three, four, or five substituents selected from C₁-C₁₀-alkyl and C₁-C₆-alkoxy. Cycloalkoxycarbonyl is preferably C₃-C₆-cycloalkoxycarbonyl, bearing no substituents or bearing one, two, three, four, or five substituents selected from C₁-C₁₀-alkyl and C₁-C₆-alkoxy. Cycloalkenyl is preferably C₃-C₁₀-cycloalkenyl, bearing no substituents or bearing one, two, three, four, or five substituents selected from C₁-C₁₀-alkyl and C₁-C₆-alkoxy. Aryl is preferably phenyl or naphthyl, bearing no substituents or bearing one, two, three, four, or five substituents selected from C₁-C₁₀-alkyl and C₁-C₆-alkoxy.

Very particular preference is given to those diphenylcyanoacrylates (I), in which each R^{1a}, R^{1b}, R^{1c}, R^{1d}, R^{1e}, R^{2a}, R^{2b}, R^{2c}, R^{2d}, and R^{2e} is hydrogen

X in formula (I) is an n-valent aliphatic or cycloaliphatic radical. X here derives from the corresponding n-valent aliphatic or cycloaliphatic alcohols via removal of the OH group: These alcohols may be linear or branched, and their carbon chains may have interruption via one or more oxygen or sulfur atoms, or via imino groups or C₁-C₄-alkylimino groups.

The group X preferably derives from the following known polyols:

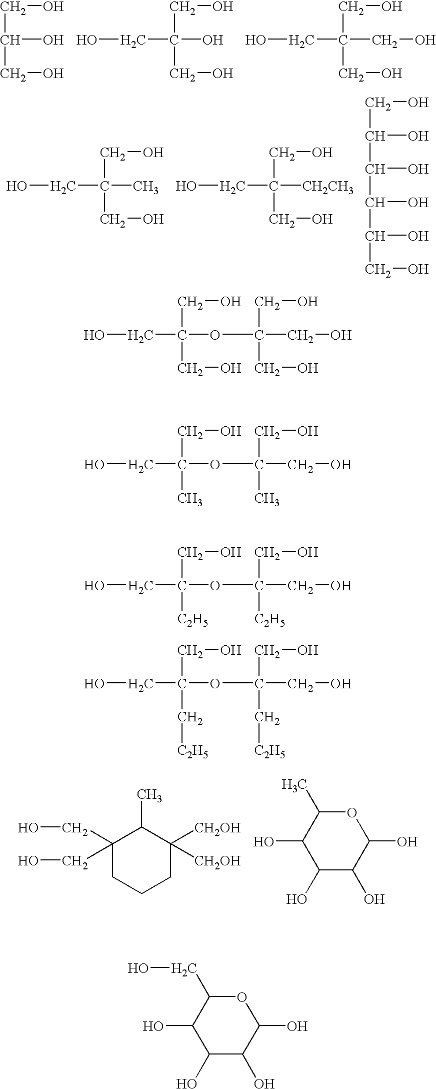

WO 96/15102 and DE 44 40 055 disclose examples of these diphenylcyanoacrylates, and the entire disclosure of those publications is hereby expressly incorporated herein. Diphenylcyanoacrylates of the formula (I) in which R^{1a}, R^{1b}, R^{1c}, R^{1d}, R^{1e}, R^{2a}, R^{2b}, R^{2c}, R^{2d}, and R^{2e} are differently defined may be prepared by corresponding processes.

One particularly preferred diphenylcyanoacrylate is 1,3-bis[(2′-cyano-3′,3′-diphenylacryloyl)oxy]-2,2-bis{[2′-cyano-3′,3′-diphenylacryloyl)-oxy]methyl}propane (CAS-No. [178671-58-4], which is commercially available, for example as Uvinul® 3030 from BASF AG, Ludwigshafen, Germany.

A suitable component ii) is in principle any of the UV absorbers which are liquid at 50° C. under standard pressure. Component ii) is preferably a component selected from the group of the benzotriazoles, diphenylcyanoacrylates, cinnamic esters, hydroxybenzophenones, hydroxyphenyltriazines, and mixtures of these. In another preferred embodiment of the present invention, component ii) comprises only those UV absorbers which are liquid under standard conditions.

In one preferred embodiment of the present invention, component ii) comprises UV absorbers of the general formula (II)

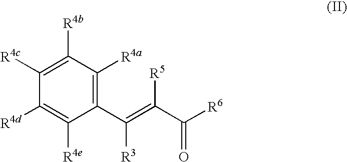

where

R³ is hydrogen or a group A,

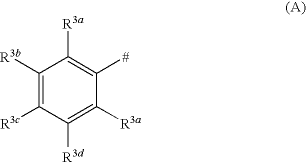

where # is the site of linkage to the acrylic skeleton and
each of R^{3a}, R^{3b}, R^{3c}, R^{3d}, and R^{3e}, independently of the others is hydrogen, alkyl, alkenyl, halogen, cyano, nitro, amino, monoalkylamino, dialkylamino, hydroxy, acyl, acyloxy, alkoxy, alkoxycarbonyl, cycloalkyl, cycloalkoxycarbonyl, cycloalkenyl, aryl, heteroaryl or heterocycloalkyl;

each of R^{4a}, R^{4b}, R^{4c}, R^{4d}, and R^{4e}, independently of the others, is hydrogen, alkyl, alkenyl, halogen, cyano, nitro, amino, monoalkylamino, dialkylamino, hydroxy, acyl, acyloxy, alkoxy, alkoxycarbonyl, cycloalkyl, cycloalkoxycarbonyl, cycloalkenyl, aryl, heteroaryl or heterocycloalkyl;

R⁵ is hydrogen or cyano;

R⁶ is OR⁷or NR⁸R⁹,
where
R⁷ is hydrogen, alkyl, alkenyl, cycloalkyl, cycloalkenyl, aryl, heteroaryl, heterocycloalkyl, or (CH₂CH₂—O)ₒ—R″;
each of R⁸ and R⁹, independently of the other, is hydrogen, alkyl, alkenyl, cycloalkyl, cycloalkenyl, aryl, heteroaryl, heterocycloalkyl, or (CH₂CH₂—O)ₒ—R″,
where
R″ is H, alkyl, or a group B,

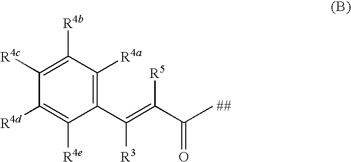

where
## indicates the terminal oxygen atom of the polyether chain;
R³, R^{4a}, R^{4b}, R^{4c}, R^{4d}, R^{4e}, and R⁵ are as defined above; and
o is a whole number from 1 to 10.

If at least one of the radicals R^{3a}, R^{3b}, R^{3c}, R^{3d}, R^{3e}, R^{4a}, R^{4b}, R^{4c}, R^{4d}, and R^{4e} is alkyl, it is preferably C₁-C₂₀-alkyl. Alkenyl is preferably C₂-C₁₀-alkenyl. Halogen is preferably chlorine or bromine. Monoalkylamino is preferably mono(C₁-C₄-alkyl)amino. Dialkylamino is preferably di(C₁-C₄-alkyl)amino. Acyl is preferably C₁C-₈-acyl. Acyloxy is preferably C₁-C₈-acyloxy. Alkoxy is preferably C₁-C₁₈-alkoxy. Alkoxycarbonyl is preferably C₁-C₁₂-alkoxycarbonyl. Cycloalkyl is preferably C₃-C₁₀-cycloalkyl, bearing no substituents or having one, two, three, four, or five substituents selected from C₁-C₁₀-alkyl and C₁-C₆-alkoxy. Cycloalkoxycarbonyl is preferably C₃-C₆-cycloalkoxycarbonyl, bearing no substituents or bearing one, two, three, four, or five substituents selected from C₁-C₁₀-alkyl and C₁-C₆-alkoxy. Cycloalkenyl is preferably C₃-C₁₀-cycloalkenyl, bearing no substituents or bearing one, two, three, four, or five substituents selected from C₁-C₁₀-alkyl and C₁-C₆-alkoxy. Aryl is preferably phenyl or naphthyl, bearing no substituents or bearing one, two, three, four, or five substituents selected from C₁-C₁₀-alkyl and C₁-C₆-alkoxy.

Furthermore, if R⁷ or at least one of the radicals R⁸ or R⁹ is alkyl, it is preferably C₁-C₂₀-alkyl whose carbon chain may have interruption via one or more non-adjacent groups selected from —O—, —S—, —NR¹⁰— (where R¹⁰ is hydrogen or C₁-C₄-alkyl), —CO—, and/or —SO₂—. Alkenyl is preferably C₂-C₁₀-alkenyl. Cycloalkyl is preferably C₃-C₁₀-cycloalkyl, bearing no substituents or bearing one, two, three, four, or five substituents selected from C₁-C₁₀-alkyl and C₁-C₆-alkoxy. Cycloalkenyl is preferably C₃-C₁₀-cycloalkenyl, bearing no substituents or bearing one, two, three, four, or five substituents selected from C₁-C₁₀-alkyl and C₁-C₆-alkoxy. Aryl is preferably phenyl or naphthyl, bearing no substituents or bearing one, two, three, four, or five substituents selected from C₁-C₁₀-alkyl and C₁-C₆-alkoxy.

R³ is preferably a radical of the formula A, in which up to three, particularly preferably one, of the radicals R^{3a}, R^{3b}, R^{3c}, R^{3d}, and R^{3e} is C₁-C₁₂-alkyl, C₁-C₁₂-alkoxy, or di(C₁-C₄-alkylamino), and the remainder of these radicals are hydrogen. In particular, R^{3c} is C₁-C₄-alkyl, C₁-C₄-alkoxy, or di(C₁-C₄-alkyl)amino, specifically methyl, ethyl, methoxy, or dimethylamino, and the remainder of these radicals are hydrogen. In another preferred embodiment of the present invention, each of R^{3a}, R^{3b}, R^{3c}, R^{3d}, and R^{3e} is hydrogen.

Compounds II in which R³ is hydrogen are equally preferred.

In formula II, it is preferable that up to three, particularly preferably one, of the radicals R^{4a}, R^{4b}, R^{4c}, R⁴d, and R^{4e} is C₁-C₁₂-alkyl, C₁-C₁₂-alkoxy, or di(C₁-C₄-alkylamino), and the remainder of these radicals are hydrogen. In particular, R^{4c} is C₁-C₄-alkyl, C₁-C₄-alkoxy, or di(C₁-C₄-alkyl)amino, specifically methyl, ethyl, methoxy, or dimethylamino, and the remainder of these radicals are hydrogen. In another preferred embodiment of the present invention, each of R^{4a}, R^{4b}, R^{4c}, R^{4d}, and R⁴ is hydrogen.

In one preferred embodiment of the present invention, R⁵ is cyano. Compounds II in which R⁵ is hydrogen are equally preferred.

In another preferred embodiment of the present invention, R⁶ is OR⁷ or is NR⁸R⁹, in which R⁷ and, respectively, R⁸ and R⁹, independently of one another, are preferably C₄-C₁₈-alkyl, in particular C₄-C₁₂-alkyl, the carbon chain of which may have interruption by one, two, three, four, five, six, or seven non-adjacent oxygen atoms, imino groups, or C₁-C₄-alkylimino groups. Particular preference is given to branched C₄-C₁₈-alkyl groups, and also to chains described by the general formula (CH₂CH₂—O)ₒ—R″, where R″ is hydrogen or alkyl, preferably C₁-C₁₈-alkyl, or a radical of the formula B,

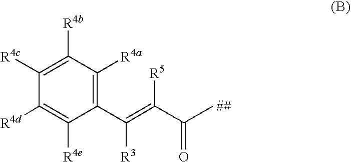

where ## indicates the terminal oxygen atom of the polyether chain; R³, R^{4a}, R^{4b}, R^{4c}, R^{4d}, R^{4e}, and R⁵ are as defined above; and in particular as defined by the preferred meanings above and o is a number from 1 to 10, preferably from 2 to 8.

In another preferred embodiment of the present invention, R⁷ is C₃-C₈-cycloalkyl, if appropriate bearing one or two substituents selected from C₁-C₄-alkyl or C₁-C₄-alkoxy.

U.S. Pat. No. 5,821,292, DE 10058290, EP 1323743, and U.S. Pat. No. 4,935,275 disclose examples of these diphenylcyanoacrylates or -amides, or phenylacrylates or -amides, and these can also be prepared by methods based on the processes described therein.

Very particularly preferred phenylacrylates of the general formula II are 2-ethylhexyl 2-cyano-3,3-diphenylacrylate (compound II where each of R^{4a}, R^{4b}, R^{4c}, R^{4d}, and R^{4e} is hydrogen, R³ is phenyl, R⁵ is cyano, and R⁶ is 2-ethylhexyloxy), and 2-ethylhexyl p-methoxycinnamate (compound II in which each of R^{4a}, R^{4b}, R^{4d}, and R^{4e} is hydrogen, R^{4c} is methoxy, R³ is hydrogen, R⁵ is hydrogen, and R⁶ is 2-ethylhexyloxy). Preference is also given to isoamyl p-methoxycinnamate (compound II, where each of R^{4a}, R^{4b}, R^{4d}, and R^{4e} is hydrogen, R^{4c} is methoxy, R³ is hydrogen, R⁵ is hydrogen, and R⁶ is isoamyloxy).

By way of example, 2-ethylhexyl 2-cyano-3,3-diphenylacrylate is available commercially as Uvinul® 3039 from BASF AG. By way of example, 2-ethylhexyl p-methoxycinnamate is available commercially as Uvinul® 3088 from BASF AG, Ludwigshafen, Germany. By way of example, isoamyl p-methoxycinnamate is available as Neo Heliopan® E1000 from Symrise.

The inventive stabilizer composition (S) may also comprise benzotriazoles as component ii). An example of a suitable benzotriazole is 2-(2H-benzotriazol-2-yl)-6-dodecyl-4-methylphenol, available commercially as Tinuvin® 571 from Ciba Specialty Chemicals, Inc.

The inventive stabilizer composition (S) may also comprise 2-hydroxybenzophenones as component ii). An example of a suitable 2-hydroxybenzophenone is 2-hydroxy-4-octoxybenzophenone, available commercially as Uvinul® 3008 from BASF AG, Ludwigshafen, Germany

To prepare the stabilizer composition (S), the solid component i) is brought into intimate contact with the liquid component ii), for example via mixing. Suitable mixing apparatuses for preparation of mixtures from liquid/solid starting materials or from starting materials that are solid under standard conditions are known to the person skilled in the art. Examples among these are mixing apparatuses based on static or dynamic mixers, e.g. stir tanks, dispersers, ultrasound homogenizers or high-pressure homogenizers. In an example of this process, a portion of one of the components i) or ii) forms an initial charge, and the other component(s) is added by usual methods. It is preferable for at least a portion of the liquid component ii) to form an initial charge. The solid component i) may then, by way of example, be added continuously or in portions.

The materials may be brought into contact at ambient temperature or with supply of heat, for example. By way of example, components i) and ii) may be heated together and then allowed to cool, or component ii) may be heated and the solid component i) may then be added to the liquid component ii). A stabilizer composition (S) is generally prepared at a temperature above ambient temperature, preferably at temperatures in the range from 25 to 200° C., in particular from 100 to 180° C. Solutions or dispersions are produced, depending on the solubility of component i) in component ii).

If component i) is completely soluble in component ii), it is generally possible to omit any use of auxiliaries in the preparation of the inventive stabilizer composition (S). This generally also applies to the preparation of stable stabilizer dispersions. For this, it is generally sufficient to expose components i) and ii) to shear forces sufficiently strong to produce stable dispersions, preferably molecular dispersions.

In one suitable procedure for preparation of the inventive stabilizer composition (S), at least one solvent is used as auxiliary. Preferred solvents are those having greater volatility than the most volatile component of the stabilizer composition (S). Among these are aliphatic, cycloaliphatic, or aromatic hydrocarbons, such as pentane, hexane, petroleum ether, cyclohexane, toluene, ethers, such as diethyl ether, tert-butyl methyl ether, tetrahydrofuran, ketones, such as acetone, diethyl ketone, or methyl ethyl ketone, alkyl carboxylates, such as ethyl acetate, or halogenated hydrocarbons, such as dichloromethane or trichloromethane. Solvents used during the preparation process may be removed via conventional processes known to the person skilled in the art after preparation of the stabilizer composition (S), for example via evaporation at reduced pressure.

The finished inventive stabilizer compositions (S) preferably comprise in essence no solvent, i.e. the proportion of solvent is below 1% by weight, based on the total weight of the stabilizer composition (S). Other auxiliaries suitable for the preparation of the inventive stabilizer composition (S) are emulsifiers, protective colloids, and dispersing agents. The inventive stabilizer compositions (S) preferably comprise no additional auxiliaries.

Particular preference is given to stabilizer compositions (S) in which component i) is 1,3-bis[(2′-cyano-3′,3′-diphenylacryloyl)oxy]-2,2-bis{[2′-cyano-3′,3′-diphenylacryloyl)-oxy]methyl}propane, and component ii) has been selected from 2′-ethylhexyl 2-cyano-3,3-diphenylacrylate, 2-ethylhexyl p-methoxycinnamate, 2-hydroxy-4-octoxybenzophenone, isoamyl p-methoxycinnamate, and 2-(2H-benzotriazol-2-yl)-6-dodecyl-4-methylphenol, and mixtures of these.

Very particular preference is given to those stabilizer compositions (S) in which component i) is 1,3-bis[(2′-cyano-3′,3′-diphenylacryloyl)oxy]-2,2-bis{[2′-cyano-3′,3′-diphenylacryloyl)oxy]methyl}propane and component ii) is 2′-ethylhexyl 2-cyano-3,3-diphenylacrylate. Equal particular preference is given to those stabilizer compositions (S) in which component i) 1,3-bis[(2′-cyano-3′,3′-diphenylacryloyl)oxy]-2,2-bis{[2′-cyano-3′,3′-diphenylacryloyl)-oxy]methyl}propane and component ii) is 2-ethylhexyl p-methoxycinnamate. Equal particular preference is given to those stabilizer compositions (S) in which component i) is 1,3-bis[(2′-cyano-3′,3′-diphenylacryloyl)oxy]-2,2-bis{[2′-cyano-3′,3′-diphenylacryloyl)-oxy]methyl}propane and component ii) is 2-(2H-benzotriazol-2-yl)-6-dodecyl-4-methyl-phenol. Equal particular preference is given to those stabilizer compositions (S) in which component i) is 1,3-bis[(2′-cyano-3′,3′-diphenylacryloyl)oxy]-2,2-bis{[2′-cyano-3′,3′-diphenylacryloyl)oxy]methyl}propane and component ii) is 2-hydroxy-4-octoxybenzophenone. Equal particular preference is given to those stabilizer compositions (S) in which component i) is 1,3-bis[(2′-cyano-3′,3′-diphenylacryloyl)oxy]-2,2-bis{[2′-cyano-3′,3′-diphenylacryloyl)-oxy]methyl}propane and component ii) is isoamyl p-methoxycinnamate.

The stabilizer composition (S) is preferably composed of, based on the total weight of the components i) and ii), from 0.001 to 50% by weight, in particular from 0.1 to 40% by weight, and very particularly preferably from 1 to 30% by weight, of component i), and of from 50 to 99.999% by weight, in particular from 60 to 99.9% by weight, and very particularly preferably from 70 to 99% by weight, of component ii).

The inventive stabilizer composition (S) is suitable for stabilization of non-living organic and living organic material, in particular for stabilization of non-living organic material, such as plastics.

The present invention also provides a polymer composition comprising a stabilizer composition (S) as defined above and at least one polymer selected from polyesters, polycarbonates, polyamides, polyolefins, polyvinyl acetals, polystyrene, copolymers of styrene or α-methylstyrene with dienes and/or with acrylic derivates, or from halogen-containing polymers, polyisocyanate polyaddition products, and mixtures of these.

The polymer composition usually comprises from 0.005 to 10% by weight, preferably from 0.01 to 5% by weight, in particular from 0.05 to 2% by weight, of the stabilizer composition (S), based on the weight of the polymer composition. The weight of the polymer composition is the weight of the polymer composition inclusive of added stabilizers, auxiliaries, or additives.

In one embodiment of the present invention, the polymer composition comprises, as polymer, at least one polyester, preferably at least one linear polyester. EP-A-0678376, EP-A-0 595 413 and, U.S. Pat. No. 6,096,854 describe suitable polyesters and copolyesters, and these publications are incorporated herein by way of reference. Polyesters are known to be condensates derived from one or more polyols and from one or more polycarboxylic acids. In linear polyesters, the polyol is a diol and the polycarboxylic acid is a dicarboxylic acid.

In another embodiment of the present invention, the polymer composition comprises a polycarbonate as polymer. By way of example, polycarbonates are produced via condensation of phosgene or carbonic esters, such as diphenyl carbonate or dimethyl carbonate, with dihydroxy compounds. Suitable dihydroxy compounds are aliphatic or aromatic dihydroxy compounds. Examples which may be mentioned of aromatic dihydroxy compounds are bisphenols, such as 2,2-bis(4-hydroxyphenyl)propane (bisphenol A), tetraalkylbisphenol A, 4,4-(meta-phenylenediisopropyl)diphenol (bisphenol M), 4,4-(para-phenylenediisopropyl)diphenol, 1,1-bis(4-hydroxyphenyl)-3,3,5-trimethylcyclohexane (BP-TMC), 2,2-bis(4-hydroxyphenyl)-2-phenylethane, 1,1-bis(4-hydroxyphenyl)cyclohexane (bisphenol Z), and also, if appropriate, mixtures of these. The polycarbonates may be branched via use of small amounts of branching agents.

In another embodiment of the present invention, the polymer composition comprises at least one polyamide as polymer. By way of example, polyamides may be prepared via polycondensation from diamines, such as hexamethylenediamine, and dicarboxylic acids, such as adipic acid. Polyamides are likewise obtainable via polycondensation from amino acids or via ring-opening polymerization from lactams, e.g. caprolactam.

In another embodiment of the present invention, the polymer composition comprises at least one polyolefin as polymer. For the purposes of the present invention, the expression “polyolefin” comprises any of the polymers whose structure is composed of olefins without other functionality, e.g. polyethylene (low- or high-density), polypropylene, linear poly-1-butene or polyisobutylene, or polybutadiene, or else copolymers of mono- or diolefins. Preferred polyolefins are the homopolymers and copolymers of ethylene, and also the homopolymers and copolymers of propylene.

In another embodiment of the present invention, the polymer composition comprises, as polymer, at least one polyvinyl acetal. Polyvinyl acetals are the products of the reaction of polyvinyl alcohol with aldehydes.

In another embodiment of the present invention, the polymer composition comprises, as polymer, at least one copolymer of styrene or of α-methylstyrene with dienes and/or with acrylic derivatives. Examples of suitable copolymers of styrene or of α-methylstyrene are styrene-butadiene copolymers, styrene-acrylonitrile copolymers (SAN), styrene-ethyl methacrylate copolymers, styrene-butadiene-ethyl acrylate copolymers, styrene-acrylonitrile-methacrylate copolymers, acrylonitrile-butadiene-styrene copolymers (ABS), or methyl methacrylate-butadiene-styrene copolymers (MBS).

In another embodiment of the present invention, the polymer composition comprises, as polymer, at least one halogen-containing polymer, such as copolymers of ethylene and of chlorinated ethylene, polymers composed of halogenated vinyl compounds, e.g. polyvinyl chloride, polyvinylidene chloride, polyvinyl fluoride, polyvinylidene fluoride, or else copolymers of these, e.g. vinyl chloride-ethylene-vinyl acetate graft copolymers, acrylate-vinyl chloride graft copolymers, vinyl chloride-vinyl acetate copolymers, vinyl chloride-styrene copolymers, vinyl chloride-acrylonitrile copolymers, vinyl chloride-vinylidene copolymers.

In one particularly preferred embodiment of the present invention, the halogen-containing polymer is polyvinyl chloride (PVC). PVC is produced via free-radical polymerization of vinyl chloride. Polyvinyl chloride is usually prepared by the emulsion polymerization, suspension polymerization, or bulk polymerization process. The polymerization process is frequently initiated via peroxides.

Polyvinyl chloride is used with varying content of plasticizers, in the form of rigid PVC with from 0 to 12% content of plasticizers, or as flexible PVC with more than 12%, or as PVC paste with very high content of plasticizers. The inventive stabilizer composition (S) may be added to the ready-to-use polyvinyl chloride. The usual method of addition is used. As an alternative, the inventive stabilizer composition (S) may be added to the monomer, and the mixture composed of monomer and inventive stabilizer composition (S) may be polymerized, or the inventive stabilizer composition (S) may be added during polymerization of the polyvinyl chloride. It is also possible for the inventive stabilizer composition (S) to be added together with a plasticizer. If appropriate, it can be advantageous to heat the mixture prior to the addition process, for example to temperatures above 50° C.

Particular preference is given to polymer compositions in which the polymer has been selected from polyisocyanate polyaddition products (polyurethanes).

Examples of suitable polyisocyanate polyaddition products are cellular polyurethanes, e.g. rigid or flexible polyurethane foams, compact polyurethanes, thermoplastic polyurethanes (TPUs), thermoset or elastic polyurethanes, or polyisocyanurates. These are well-known, and their preparation has been widely described. They are usually prepared via reaction of bifunctional or higher-functionality isocyanates, or of corresponding isocyanate analogs, with compounds reactive toward isocyanates. The preparation follows conventional processes, for example the one-shot process or prepolymer process, e.g. in molds, in a reactive extruder, or else on a belt system. One specific preparation process is provided by reaction injection molding (RIM), which is preferably used for preparation of polyurethanes with a foamed or compact core and with a mainly compact, non-porous surface. The inventive stabilizer compositions (S) are advantageously suitable for all of these processes.

The structure of polyurethanes is generally composed of at least one polyisocyanate and of at least one compound having, per molecule, at least two groups reactive toward isocyanate groups. Suitable polyisocyanates preferably have from 2 to 5 NCO groups. The groups reactive toward isocyanate groups are preferably groups selected from hydroxy, mercapto, primary and secondary amino groups. Preference is given here to difunctional or higher-functionality polyols.

Suitable polyisocyanates are aliphatic, cycloaliphatic, araliphatic and aromatic isocyanates. Examples of suitable aromatic diisocyanates are diphenylmethane 2,2′-2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethyldiphenyl diisocyanate, diphenylethane 1,2-diisocyanate and/or phenylene diisocyanate. Aliphatic and cycloaliphatic diisocyanates comprise by way of example, tri-, tetra-, penta-, hexa-, hepta-, and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and/or dicyclohexylmethane 4,4′-, 2,4′-, and/or 2,2′-diisocyanate. Among the preferred diisocyanates are hexamethylene diisocyanate (HMDI) and isophorone diisocyanate. Examples of higher-functionality isocyanates are triisocyanates, e.g. triphenylmethane-4,4′,4″-triisocyanate, and the cyanurates of the abovementioned diisocyanates, and also the oligomers obtainable via partial reaction of diisocyanates with water, e.g. the biurets of the abovementioned diisocyanates, and also oligomers obtainable via controlled reaction of semiblocked diisocyanates with polyols, which have an average of more than 2, and preferably 3 or more, hydroxy groups.

The polyol components used here for rigid polyurethane foams, which may, if appropriate, have isocyanurate structures, are high-functionality polyols, in particular polyether polyols based on high-functionality alcohols, sugar alcohols, and/or saccharides as starter molecules. For flexible polyisocyanate polyaddition products, e.g. flexible polyurethane foams or RIM materials, preferred polyols are di- and/or trifunctional polyether polyols based on glycerol and/or on trimethylolpropane and/or on glycols as starter molecules, and di- and/or trifunctional polyester polyols based on glycerol and/or on trimethylolpropane and/or on glycols as alcohols for esterification. Thermoplastic polyurethanes are usually based on mainly difunctional polyester polyalcohols and/or on polyether polyalcohols which preferably have an average functionality of from 1.8 to 2.5, particularly preferably from 1.9 to 2.1.

The preparation of these polyether polyols follows known technology. Examples of suitable alkylene oxides for preparation of the polyols are propylene 1,3-oxide, butylene 1,2- or 2,3-oxide, styrene oxide, and preferably ethylene oxide and propylene 1,2-oxide. The alkylene oxides may be used individually, alternating in succession, or in the form of mixtures. It is preferable to use alkylene oxides which give primary hydroxy groups in the polyol. Polyols particularly preferably used are those which have been alkoxylated with ethylene oxide to conclude the alkoxylation process, and therefore have primary hydroxy groups. Other suitable polyetherols are polytetrahydrofurans and polyoxymethylenes. The polyether polyols preferably have a functionality of from 2 to 6, in particular from 2 to 4, and have molecular weights of from 200 to 10 000, preferably from 200 to 8000.

By way of example, suitable polyester polyols may be prepared from organic dicarboxylic acids having from 2 to 12 carbon atoms, preferably aliphatic dicarboxylic acids having from 4 to 6 carbon atoms, and from polyfunctional alcohols, preferably diols, having from 2 to 12 carbon atoms, preferably from 2 to 6 carbon atoms. The polyester polyols preferably have a functionality of from 2 to 4, in particular from 2 to 3, and a molecular weight of from 480 to 3000, preferably from 600 to 2000, and in particular from 600 to 1500.

The polyol component may also comprise diols or higher-functionality alcohols. Suitable diols are glycols preferably having from 2 to 25 carbon atoms. Among these are 1,2-ethanediol, 1,2-propanediol, 1,3-propanediol, 1,4-butanediol, 1,5-pentanediol, 1,6-hexanediol, 1,10-decanediol, diethyleneglycol, 2,2,4-trimethyl-1,5-pentanediol, 2,2-dimethyl-1,3-propanediol, 1,4-dimethylolcyclohexane, 1,6-dimethylolcyclohexane, 2,2-bis(4-hydroxyphenyl)propane (bisphenol A), 2,2-bis(4-hydroxyphenyl)butane (bisphenol B), or 1,1-bis(4-hydroxyphenyl)-3,3,5-trimethylcyclohexane (bisphenol C). Examples of suitable higher-functionality alcohols are trifunctional alcohols (triols), tetrafunctional alcohols (tetrols), and/or pentafunctional alcohols (pentols). They generally have from 3 to 25, preferably from 3 to 18, carbon atoms. Among these are glycerol, trimethylolethane, trimethylolpropane, erythritol, pentaerythritol, sorbitol and alkoxylates of these.

However, it can prove advantageous to add chain extenders, crosslinking agents, stoppers, or else, if appropriate, mixtures of these in order to modify mechanical properties such as hardness. By way of example, the chain extenders and/or crosslinking agents have a molecular weight of from 40 to 300. Examples of those which may be used are aliphatic, cycloaliphatic, and/or araliphatic diols having from 2 to 14, preferably from 2 to 10, carbon atoms, e.g. ethylene glycol, 1,3-propanediol, 1,2-propanediol, 1,10-decanediol, 1,2-, 1,3-, 1,4-dihydroxycyclohexane, diethylene glycol, dipropylene glycol, and preferably ethylene glycol, 1,4-butanediol, 1,6-hexanediol, and bis(2-hydroxyethyl)hydroquinone, triols, e.g. 1,2,4- or 1,3,5-trihydroxycyclohexane, glycerol, trimethylolpropane, triethanolamine, and low-molecular-weight hydroxy-containing polyalkylene oxides based on ethylene oxide and/or on propylene 1,2-oxide, and on the abovementioned diols and/or triols as starter molecules.

Examples of suitable stoppers comprise monofunctional alcohols or secondary amines.

The present invention therefore also provides a process for preparation of polyisocyanate polyaddition products via reaction of isocyanates with compounds reactive toward isocyanates, where the reaction takes place in the presence of a stabilizer composition (S) as defined above.

In relation to suitable isocyanates and to suitable compounds reactive toward isocyanates, reference is made to what has been said above.

To prepare the polyisocyanate polyaddition products, the isocyanates and the compounds reactive toward isocyanates are preferably reacted in amounts such that the equivalent ratio of NCO groups of the isocyanates to the entirety of the reactive hydrogen atoms of the compounds reactive toward isocyanates is from 0.85 to 1.25:1, preferably from 0.95 to 1.15:1, and in particular from 1 to 1.05:1. If in particular the rigid polyurethane foams contain at least some isocyanurate groups, the ratio usually used of NCO groups to the entirety of the reactive hydrogen atoms is from 1.5 to 60:1, preferably from 1.5 to 8:1.

In the inventive process, the stabilizer composition (S) may be added to the isocyanate component, to the component reactive toward isocyanate, or both to the isocyanate component and to the component reactive toward isocyanate. In the inventive process, the inventive stabilizer composition (S) is preferably added to the component reactive toward isocyanates, known as the polyol component. It is advantageous to heat the stabilizer composition (S) prior to addition, for example to a temperature above 50° C. This method generally permits problem-free homogeneous dispersion of the stabilizer composition in the component reactive toward isocyanates. By way of example, mixing of the stabilizer composition (S) with the polyol component may take place in a mixer.

Other stabilizers in addition to the inventive stabilizer composition (S) may be added to the polyol component or to the isocyanate component. Suitable additional stabilizers comprise at least one antioxidant selected from the group of the phosphites, the sulfites, phenothiazine, aromatic amines, benzofuranones, and/or dilauryl 3,3′-thiodipropionate, and mixtures of these.

Examples of suitable phosphites are trisnonylphenyl phosphite, triphenyl phosphite, didecyl phenyl phosphite, and tris(2,4-di-tert-butylphenyl) phosphite, and mixtures of these.

An example of a suitable aromatic amine is di(4-(1,1,3,3-tetramethylbutyl)phenylamine (available for example as Irganox® 5077, from Ciba Specialty Chemicals, Inc.).

Examples of suitable benzofuranones are 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one and mixtures of these.

Particularly preferred antioxidants are trisnonyl phenyl phosphite, triphenyl phosphite, phenothiazine, tris(2,4-di-tert-butylphenyl) phosphite, didecyl phenyl phosphite, and/or dilauryl 3,3′-thiodipropionate, and mixtures of these.

If concomitant use is made of at least one antioxidant, the proportion of antioxidant, based on the weight of the polymer composition is from 0.0001 to 10% by weight, preferably from 0.01 to 1% by weight.

The reaction between the polyol component and the isocyanate component may also take place in the presence of at least one other component selected from costabilizers, blowing agents, catalysts, colorants, and additives.

Suitable costabilizers comprise sterically hindered amines and sterically hindered phenols.

Examples of suitable sterically hindered amines are diphenylamine, bis(4-octylphenyl)-amine, bis(2,2,6,6-tetramethylpiperidyl) sebacate, bis(1,2,2,6,6-pentamethylpiperidyl) sebacate, bis(1,2,2,6,6-pentamethylpiperidyl) esters, N,N′-bis(formyl)bis(2,2,6,6-tetramethyl-4-piperidyl)-1,6-hexanediamine, the condensate of 1,4-dihydroxy-2,2,6,6-tetramethylpiperidine and succinic acid, the condensate of N,N′-(2,2,6,6-tetramethylpiperidyl)hexamethylenediamine and 4-tert-octylamino-2,6-dichloro-1,3,5-s-triazine, poly[3-(eicosyl/tetracosyl)-1-(2,2,6,6-tetramethyl-4-piperidinyl)-2,5-pyrrolidinedione], tris(2,2,6,6-tetramethylpiperidyl) nitrilotriacetate, tetrakis(2,2,6,6-tetramethyl-4-piperidyl) 1,2,3,4-butanetetracarboxylate, 1,1′-(1,2-ethanediyl)bis(3,3,5,5-tetramethylpiperazinone), bis(2,2,6,6-tetramethyl-1-octoxypiperidyl) sebacate (by way of example commercially available as Tinuvin® 123 from Ciba Specialty Chemicals, Inc.), the condensate of 4-amino-2,2,6,6-tetramethylpiperidines and tetramethylolacetylenediureas, and mixtures of these. If concomitant use is made of at least one sterically hindered amine, the proportion of sterically hindered amine, based on the weight of the polymer composition, is from 0.0001 to 10% by weight, preferably from 0.01 to 1% by weight.

In another preferred embodiment of the present invention, the reaction is carried out not only in the presence of at least one sterically hindered amine but also in the presence of at least one antioxidant.

Examples of suitable sterically hindered phenols are 2,6-di-tert-butyl-4-methylphenol, n-octadecyl β-(3,5-di-tert.-butyl-4-hydroxyphenol)propionate, 1,1,3-tris-(2-methyl-4-hydroxy-5-tert.-butylphenyl)butane, 1,3,5-trimethyl-2,4,6-tris(3,5-di-tert-butyl-4-hydroxybenzyl)benzene, 1,3,5-tris-(3,5-di-tert-butyl-4-hydroxybenzyl) isocyanurate, 1,3,5-tris-[β-(3,5-di-tert-butyl-4-hydroxyphenyl)propionylethyl] isocyanurate, 1,3,5-tris-(2,6-di-methyl-3-hydroxy-4-tert-butylbenzyl) isocyanurate, and pentaerythrityl tetrakis[β-(3,5-di-tert-butyl-4-hydroxy)propionate]. Preferred sterically hindered phenols are triethylene glycol bis[3-(5-tert-butyl-4-hydroxy-m-tolyl)]propionate (available, by way of example, as Irganox® 245, from Ciba Specialty Chem., Inc.), bis(2-[3-(3,5-di-tert-butyl-4-hydroxyphenyl)propionyloxy]ethyl)sulfide (available, by way of example, as Irganox® 1035 from Ciba Specialty Chemicals, Inc.), octadecyl 3-(3,5-di-tert-butyl-4-hydroxyphenyl)propionate (available, by way of example, as Irganox® 1076 from Ciba Specialty Chemicals, Inc.), N,N-hexamethylenebis(3,5-di-t-butyl-4-hydroxyphenyl)-propionamide (available, by way of example, as Irganox® 1098 from Ciba Specialty Chemicals, Inc.), isooctyl 3-(3,5-di-tert-butyl-4-hydroxyphenyl)propionate (available, by way of example, as Irganox® 1135 from Ciba Specialty Chemicals, Inc.), 2′,3-bis-[3-(3,5-di-tert-butyl-4-hydroxyphenyl)propionyl]propionohydrazide (available, by way of example, as Irganox® MD 1024 from Ciba Specialty Chemicals, Inc.). If concomitant use is made of at least one sterically hindered phenol, the proportion of sterically hindered phenol, based on the weight of the polymer composition, is from 0.0001 to 10% by weight, preferably from 0.01 to 1% by weight.

The blowing agent used, in particular for production of polyurethane foams, may comprise conventional chemical blowing agents, such as water and/or physical blowing agents. Suitable physical blowing agents here are liquids which are inert toward the organic, if appropriate modified, polyisocyanates and have boiling points below 100° C., preferably below 50° C., in particular from −50 to 30° C. at standard pressure, and therefore evaporate when exposed to the exothermic polyaddition reaction. Examples of the liquids which may be used with preference are alkanes, such as heptane, hexane, n- and isopentane, preferably technical mixtures composed of n- and isopentanes, n- and isobutane, and propane, cycloalkanes, such as cyclopentane and/or cyclohexane, ethers, such as furan, dimethyl ether, and diethyl ether, ketones such as acetone and methyl ethyl ketone, alkyl carboxylates, such as methyl formate, dimethyl oxalate and ethyl acetate, and halogenated hydrocarbons, such as conventional fluorocarbons and/or chlorocarbons, e.g. dichloromethane. Mixtures of these low-boiling liquids with one another and/or with other substituted or unsubstituted hydrocarbons may also be used. Other suitable compounds are organic carboxylic acids, e.g. formic acid, acetic acid, oxalic acid, ricinoleic acid, and carboxy-containing compounds. The blowing agents are usually added to the compounds reactive toward isocyanates. However, they may be added to the isocyanate component or added in combination both to the polyol component and also to the isocyanate component, or added to premixes of these components with the other structural components. The amount used of the physical blowing agent is preferably from 0 to 25% by weight, particularly preferably from 0 to 15% by weight, based in each case on the weight of all of the compounds used reactive toward isocyanates. If water is used as blowing agent, the amount of water preferably used is from 0.1 to 10% by weight, particularly preferably from 0.1 to 7% by weight, based in each case on the weight of all the compounds used reactive toward isocyanates, this water preferably being added to the polyol component, and preference being given to the use of water in combination with at least one of the physical blowing agents mentioned, such as cyclopentane, n- and/or isopentane.

Catalysts used may comprise well-known compounds which markedly accelerate the reaction of isocyanates with the compounds reactive toward isocyanates, the total catalyst content used preferably being from 0.001 to 0.1% by weight, based on the weight of all of the compounds used reactive toward isocyanates. Examples of compounds which be used are the following: triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl or N-ethylmorpholine, N-cyclohexylmorpholine, N,N,N′,N′-tetramethylethylenediamine, N,N,N′,N′-tetramethylbutanediamine, N, N, N′,N′-tetramethyl-1,6-hexanediamine, pentamethyldiethylenetriamine, dimethylpiperazine, N-dimethylaminoethylpiperidine, 1,2-dimethylimidazole, 1-azabicyclo-[2.2.0]-octane, 1,4-diazabicyclo[2.2.2]octane (DABCO) and alkanolamine compounds, such as triethanolamine, triisopropanolamine, N-methyl- and N-ethyldiethanolamine, dimethylaminoethanol, 2-(N,N-dimethylaminoethoxy)ethanol, N,N′,N-tris(dialkylaminoalkyl)hexahydrotriazines, e.g. N,N′,N-tris-(dimethylaminopropyl)-s-hexahydrotriazine, ferrous chloride, zinc chloride, lead octoate, titanic esters, and preferably tin salts, such as stannous dioctoate, diethyltin hexoate, dibutyltin dilaurate, and/or dibutyldilauryltin mercaptide, 2,3-dimethyl-3,4,5,6-tetrahydropyrimidine, tetraalkylammonium hydroxides, such as tetramethylammonium hydroxide, alkali metal hydroxides, such as sodium hydroxide, alkali metal alcoholates, such as sodium methoxide and potassium isopropoxide, and/or alkali metal salts of long-chain fatty acids having from 10 to 20 carbon atoms and, if appropriate, having pendant OH groups.

For the purposes of the present invention, the expression “colorants” means not only dyes but also inorganic or organic pigments. If concomitant use is made of colorant, the proportion of colorant, based on the total weight of the compounds reactive toward isocyanates is generally from 1 to 6% by weight.

Examples of suitable additives are surfactants, foam stabilizers, cell regulators, fillers, flame retardants, hydrolysis stabilizers, fungistatic substances, bacteriostatic substances, and mold-release agents.

Examples of surfactants which may be used are compounds which serve to promote the homogenization of the starting materials and, if appropriate, are also suitable for regulating the cell structure of the plastics. By way of example, mention may be made of emulsifiers, such as the sodium salts of castor oil sulfates, or of fatty acids, and also salts of fatty acids with amines, e.g. diethylammonium oleate, diethanolammonium stearate, diethanolammonium ricinoleate, salts of sulfonic acids, e.g. the alkali metal or ammonium salts of dodecylbenzene- or dinaphthylmethanedisulfonic acid and ricinoleic acid; foam stabilizers, such as siloxane-oxalkylene copolymers and other organopolysiloxanes, ethoxylated alkylphenols, ethoxylated fatty alcohols, paraffin oils, castor oil esters or ricinoleic esters, Turkish red oil, and peanut oil, and cell regulators, such as paraffins, fatty alcohols, and dimethylpolysiloxanes. Other suitable compounds for improving the emulsifying action, the cell structure and/or the stabilization of the foam are the oligomeric acrylates described above having polyoxyalkylene radicals and fluoroalkane radicals as pendant groups. The amounts usually used of the surfactants are from 0.01 to 5% by weight, based on 100% by weight of the total amount of compounds used reactive toward isocyanates.

Fillers, in particular reinforcing fillers are the usual organic and inorganic fillers, reinforcing agents, weighting agents, agents for improving abrasion performance in paints, coating compositions, etc., these being known per se. Individual examples which may be mentioned are: inorganic fillers, such as carbon and in particular carbon fibers, silicatic minerals, such as phyllosilicates, e.g. antigorite, serpentine, hornblendes, amphiboles, chrysotile, and talc, metal oxides, such as kaolin, aluminum oxides, titanium oxides, and iron oxides, metal salts, such as chalk, baryte, and inorganic pigments, such as cadmium sulfide and zinc sulfide, and also glass, inter alia. It is preferable to use kaolin (china clay), aluminum silicate, and coprecipitates composed of barium sulfate and aluminum silicate, and also natural or synthetic fibrous minerals, such as wollastonite, and fibers composed of metal or in particular of glass and of various lengths, if appropriate coated with a size. Examples of organic fillers which may be used are: melamine, colophony, cyclopentadienyl resins, and graft polymers, and also cellulose fibers, polyamide fibers, polyacrylonitrile fibers, polyurethane fibers, polyester fibers based on aromatic and/or on aliphatic dicarboxylic esters. The inorganic and organic fillers may be used individually or as mixtures, and the amounts of these added to the reaction mixture are advantageously from 0.5 to 50% by weight, preferably from 1 to 40% by weight, based on the weight of the isocyanates and the weight of the entirety of compounds used reactive toward isocyanates, although the content of mats, nonwovens, and wovens composed of natural or synthetic fibers can reach values up to 80% by weight.

Examples of suitable flame retardants are tricresyl phosphate, tris(2-chloroethyl) phosphate, tris(2-chloropropyl) phosphate, tris(1,3-dichloropropyl) phosphate, tris(2,3-dibromopropyl) phosphate, tetrakis(2-chloroethyl) ethylenediphosphate, dimethyl methanephosphonate, diethyl diethanolaminomethylphosphonate, and also commercially available halogen-containing flame-retardant polyols. Besides the abovementioned halogen-substituted phosphates, use may also be made of inorganic or organic flame retardants such as red phosphorus, aluminum oxide hydrate, antimony trioxide, arsenic oxide, ammonium polyphosphate, and calcium sulfate, expandable graphite, or cyanuric acid derivatives, e.g. melamine, or of a mixture composed of at least two flame retardants, e.g. ammonium polyphosphates and melamine, other materials which may be used, if appropriate, to provide flame retardancy to the polyisocyanate polyaddition products being maize starch or ammonium polyphosphate, melamine, and expandable graphite, and/or, if appropriate, aromatic polyesters. It has generally proven advantageous to use from 5 to 50% by weight, preferably from 5 to 25% by weight, of the flame retardants mentioned, based on the weight of all of the compounds used reactive toward isocyanates.

Examples of suitable hydrolysis stabilizers are carbodiimides and epoxides.

Examples of suitable mold-release agents are silicones, waxes, metal salts of fatty acids, e.g. calcium stearate, lead stearate, magnesium stearate, aluminum stearate, zinc stearate, fats, talc, or mica.

In the inventive process, any antioxidant used concomitantly and any other component(s) used concomitantly may, in principle be added to the isocyanate component and/or to the polyol component. The addition may take place simultaneously with the addition of the stabilizer composition (S) to the isocyanate component and/or polyol component, or take place prior to or after that addition.

The polyisocyanate polyaddition products are advantageously prepared by the one-shot process, for example with the aid of high-pressure or low-pressure technology, in open or closed molds, for example in metallic molds or in reactive extruders, in particular for preparation of thermoplastic polyurethanes. Another conventional process is continuous application of the reaction mixture to suitable belt lines to produce panels.

It has proven particularly advantageous to operate with the two-component process and to combine the compounds reactive toward isocyanates, the stabilizer composition (S) and any antioxidant(s), the blowing agent(s), catalysts, sterically hindered amine(s), sterically hindered phenol(s), colorants, and additives in component (A), and to use the isocyanates or mixtures composed of the isocyanates and, if appropriate, blowing agents as component (B).

The starting components A and B are mixed at a temperature of from 0 to 100° C., preferably from 20 to 60° C., depending on the application, and introduced into the open mold or, if appropriate, at increased pressure into the closed mold, or, in the case of a continuous operating unit, applied to a belt which receives the reaction mixture. The mechanical mixing method may be used, by means of a stirrer or of a mixing screw. The temperature of the mold or, if no mold is used, the temperature at which the reaction takes place is usually at least 30° C., preferably from 35 to 110° C.

The present invention also provides the use of a stabilizer composition (S) as defined above for stabilization of polymer compositions which comprise at least one polymer selected from polyesters, polycarbonates, polyamides, polyolefins, polyvinyl acetals, polystyrene, copolymers of styrene or of α-methylstyrene with dienes and/or with acrylic derivates, polyisocyanate polyaddition products, and halogen-containing polymers, and mixtures of these, with respect to exposure to light.

The inventive stabilizer composition (S) has good suitability for stabilization of moldings composed of polyisocyanate polyaddition products, because it can be dispersed or dissolved without difficulty in the component reactive toward isocyanates, thus permitting achievement of homogeneous dispersion of the stabilizer composition in the polyisocyanate polyaddition product. An equally suitable use is the stabilization of moldings composed of polyvinyl chloride. Moldings composed of polyisocyanate polyaddition products, polyvinylamide, or polyvinyl chloride are used, by way of example, as housings, protective coverings, or dashboards in means of transport. Examples of the means of transport are means of road transport, such as cars, trucks, buses, means of rail transport such as streetcars, overhead railways, conventional railways, rack railways, means of water transport, such as ships and hovercraft, and also means of air transport, such as aircraft and helicopters. In one preferred embodiment of the present invention, the inventively stabilized moldings are used in the interior of means of transport.

The moldings stabilized by using the inventive stabilizer composition (S) and composed of polyvinyl chloride or of a polyisocyanate polyaddition product are preferably used for production of dashboards for cars or trucks, for aircraft or ships, and in particular for cars or trucks.

The fogging values of the inventively stabilized polymer compositions are lower than those of polymer compositions stabilized with the stabilizers or stabilizer compositions known from the prior art. Determination of the fogging performance of a polymer composition consists in determining the amount of condensation of volatile constituents from a polymer composition. The fogging value determined at 100° C. over a period of 16 hours to DIN 75201 is generally below 1.5 mg, preferably below 1.0 mg, and in particular below 0.8 mg for an inventively stabilized polymer composition, the stabilizer concentration used being 0.5% by weight, based on the weight of the polyol component.

The inventive stabilizer composition (S) features good compatibility and solubility in the abovementioned polymer compositions. They are generally slightly yellowish, and at the temperatures generally used for plastics processing they are stable and non-volatile. The inventively stabilized polymer compositions and the moldings produced therefrom feature a longer lifetime, because escape of the inventive stabilizer composition(s) by evaporation from the polymer composition or from the moldings produced therefrom is slower than that of the light stabilizers known from the prior art.

The examples below provide further illustration of the invention.

### EXAMPLES

### Example 1

### Preparation of Stabilizer Composition (S1)

Four parts of 2′-ethylhexyl 2-cyano-3,3-diphenylacrylate, available by way of example as Uvinul® 3039 from BASF AG, Ludwigshafen, Germany, were heated to 70° C. One part of 1,3-bis[(2′-cyano-3′,3′-diphenylacryloyl)oxy]-2,2-bis{[2′-cyano-3′,3′-diphenyl-acryloyl)oxy]methyl}propane, commercially available, by way of example, as Uvinul® 3030 from BASF AG, Ludwigshafen, Germany, was then added, and the mixture was heated to 125-130° C. The suspension was stirred until the solids had dissolved and a clear solution had been produced. This gave an amber-colored, viscous stabilizer composition (S1). The kinematic viscosity, determined using a capillary viscometer at 20° C. to DIN 51562-1, was 98 200 mm²s⁻¹.

### Example 2-6

### Incorporation of the Stabilizers in Polyurethane

0.5% by weight of stabilizer or 0.5% by weight of stabilizer composition (S1) was dissolved in the polyol component (polyester polyol) of the polyurethane to be prepared, and the material was then processed together with an aliphatic isocyanate in the form of a mixture, using a spray gun and the spray technology process, to give a black-colored skin. In example 2 (control), no stabilizer was present in the polyurethane. In comparative examples 3 (stabilizer: 2-(2H-benzotriazol-2-yl)-4,6-di-tert-pentylphenol, commercially available by way of example as Uvinul® 3028 from BASF AG, Ludwigshafen, Germany) and 5 (stabilizer: a high-molecular-weight diphenylcyanoacrylate, 1,3-bis[(2′-cyano-3′,3′-diphenylacryloyl)oxy]-2,2-bis{[2′-cyano-3′,3′-diphenylacryloyl)oxy]methyl}propane, commercially available by way of example as Uvinul® 3030 from BASF AG, Ludwigshafen, Germany), the stabilizer is solid under standard conditions, and in comparative example 4 (stabilizer: 2′-ethylhexyl 2-cyano-3,3-diphenylacrylate, commercially available by way of example as Uvinul® 3039 from BASF AG, Ludwigshafen, Germany) the stabilizer is liquid under standard conditions. The photostability of the stabilized skin, and also of an unstabilized skin, was determined (6 months, Florida, under glass). The results are given in table 1.

TABLE 1

| Ex. | Stabilizer | Conc.* | Incorporation** | Photostability*** |
|---|---|---|---|---|
| 2 | None (control) | | | − |
| 3 | 2-(2H-benzotriazol-2-yl)-4,6-di- | 0.5% | 0 | + |
| | tert-pentylphenol (comparison) | | | |
| 4 | 2′-ethylhexyl 2-cyano-3,3- | 0.5% | + | + |
| | diphenylacrylate (comparison) | | | |
| 5 | 1,3-bis[(2′-cyano-3′,3′- | 0.5% | − | + |
| | diphenylacryloyl)oxy]-2,2-bis{[2′- | | | |
| | cyano-3′,3′-diphenylacryloyl)- | | | |
| | oxy]methyl}propane (comparison) | | | |
| 6 | (S1) | 0.5% | + | + |

*based on polyol component
**key to symbols: +: good suitability, 0: suitable, −: unsuitable.
***key to symbols: + adequate photostability, −: inadequate photostability.

As can be seen from table 1, all of the UV absorbers are suitable for increasing the photostability of the polyurethanes. However, very good processing requires liquid UV absorbers or liquid stabilizer mixtures.

### Examples 7-9

### Fogging Performance of Stabilized Polyurethanes

The fogging value of the stabilized polyurethane skins from examples 3, 4 and 6 was determined according to DIN 75201. For this, the test specimen was placed on the base of a standard glass beaker. The beaker is covered with a glass plate on which the volatile constituents from the test specimen can condense. This glass plate is cooled. The beaker thus prepared is placed for 16 hours in a bath thermostate at a test temperature of 100° C. (±0.3° C.). The amount of fogging deposit on the glass plate is determined via measurement of the 60° reflectometer values. The reference used here was the 60° reflectometer values of the same glass plate without deposit, the plate having been carefully cleaned prior to the experiment. Table 2 gives the fogging values measured.

TABLE 2

| Ex. | Stabilizer | Conc.* | Fogging value |
|---|---|---|---|
| 7 | 2-(2H-benzotriazol-2-yl)-4,6-di-tert- | 0.5% | 2.1 mg |
| | pentylphenol | | |
| 8 | 2′-ethylhexyl 2-cyano-3,3- | 0.5% | 1.5 mg |
| | diphenylacrylate | | |
| 9 | S1 | 0.5% | 0.5 mg |

*based on polyol component

The examples show that an inventive stabilizer mixture (S) has markedly lower fogging than stabilizers of the prior art. The polymer compositions stabilized using the inventive stabilizer composition (S) therefore exhibit markedly better quality features when compared with polymer compositions stabilized with conventional UV absorbers. The amount of stabilizer escaping by evaporation from the inventively stabilized polymer is markedly lower than that from the known stabilizers of the prior art.

1. A stabilizer composition (S), composed of:
(i) at least one UV absorber solid under standard conditions, selected from the group consisting of the diphenylcyanoacrylates having a molar mass of at least 500 g/mol and
(ii) at least one UV absorber which is liquid at 50° C. and standard pressure.

2. The stabilizer composition (S) according to claim 1, wherein component ii) has a molar mass of less than 400 g/mol.

3. The stabilizer composition (S) according to claim 1 wherein component i) comprises at least one diphenylcyanoacrylate of the formula (I) 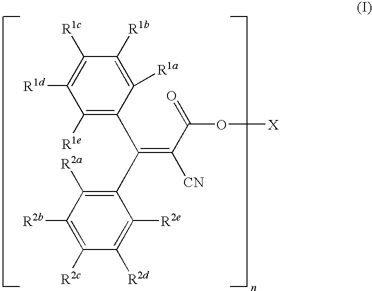
in which
each of R^{1a}, R^{1b}, R^{1c}, R^{1d}, R^{1e}, R^{2a}, R^{2b}, R^{2c}, R^{2d} and R^{2e}, independently of the others, is hydrogen, alkyl, alkenyl, halogen, cyano, nitro, amino, monoalkylamino, dialkylamino, hydroxy, acyl, acyloxy, alkoxy, alkoxycarbonyl, cycloalkyl, cycloalkoxycarbonyl, cycloalkenyl, aryl, heteroaryl, or heterocycloalkyl;
n is a whole number from 3 to 10; and
X is an n-valent aliphatic or cycloaliphatic radical having from 3 to 20 carbon atoms, where a cycloaliphatic radical may also have interruption via from 1 to 2, and an aliphatic radical via 1, 2, 3, 4, 5, 6, 7, 8, or 9, non-adjacent oxygen atoms, sulfur atoms, imino groups, or C₁-C₄-alkylimino groups.

4. The stabilizer composition (S) according to claim 1, wherein component i) is 1,3-bis[(2′-cyano-3′,3′-diphenylacryloyl)oxy]-2,2-bis{[2′-cyano-3′,3′-diphenylacryloyl)oxy]methyl}propane.

5. The stabilizer composition (S) according to claim 1, wherein component ii) is selected from the group consisting of the benzotriazoles, diphenylcyanoacrylates, cinnamic esters, hydroxybenzophenones, hydroxyphenyltriazines, and mixtures thereof.

6. The stabilizer composition (S) according to claim 1, wherein component ii) comprises at least one compound of formula (II), 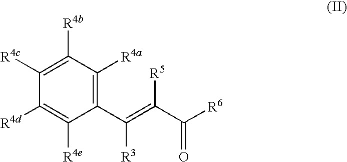
in which
R³ is hydrogen or a group A, 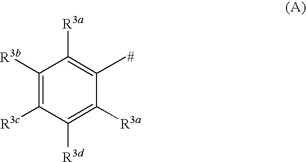
wherein # is the site of linkage to the acrylic skeleton and
each of R^{3a}, R^{3b}, R^{3c}, R^{3d}, and R^{3e}, independently of the others is hydrogen, alkyl, alkenyl, halogen, cyano, nitro, amino, monoalkylamino, dialkylamino, hydroxy, acyl, acyloxy, alkoxy, alkoxycarbonyl, cycloalkyl, cycloalkoxycarbonyl, cycloalkenyl, aryl, heteroaryl or heterocycloalkyl;
each of R^{4a}, R^{4b}, R^{4c}, R^{4d}, and R^{4e}, independently of the others, is hydrogen, alkyl, alkenyl, halogen, cyano, nitro, amino, monoalkylamino, dialkylamino, hydroxy, acyl, acyloxy, alkoxy, alkoxycarbonyl, cycloalkyl, cycloalkoxycarbonyl, cycloalkenyl, aryl, heteroaryl or heterocycloalkyl;
R⁵ is hydrogen or cyano; and
R⁶ is OR⁷ or NR⁸R⁹,
wherein
R⁷ is hydrogen, alkyl, alkenyl, cycloalkyl, cycloalkenyl, aryl, heteroaryl, heterocycloalkyl, or (CH₂CH₂—O)ₒ—R″;
each of R⁸ and R⁹ , independently of the other, is hydrogen, alkyl, alkenyl, cycloalkyl, cycloalkenyl, aryl, heteroaryl, heterocycloalkyl, or (CH₂CH₂—O)ₒ—R″,
in which
R″ is H, alkyl, or a group B, 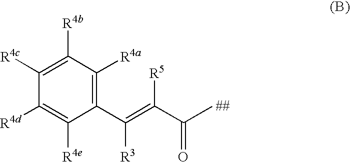
wherein
## indicates the terminal oxygen atom of the polyether chain;
R³, R^{4a}, R^{4b}, R^{4c}, R^{4d}, R^{4e} and R⁵ are as defined above; and
o is a whole number from 1 to 10.

7. The stabilizer composition (S) according to claim 1, wherein component ii) is selected from 2-ethylhexyl 2-cyano-3,3-diphenylacrylate, 2-ethylhexyl p-methoxycinnamate, isoamyl p-methoxycinnamate, and mixtures thereof.

8. The stabilizer composition (S) according to claim 1, wherein component ii) is selected from 2-(2H-benzotriazol-2-yl)-6-dodecyl-4-methylphenol, 2-hydroxy-4-octoxybenzophenone, and mixtures thereof.

9. The stabilizer composition (S) according to claim 1, which is liquid under standard conditions.

10. The stabilizer composition (S) according to claim 1, wherein the proportion present of component i) is from 0.001 to 50% by weight and the proportion present of component ii) is from 50 to 99.999% by weight, based on the total weight of components i) and ii).

11. A polymer composition, comprising a stabilizer composition (S) as defined in claim 1, and at least one polymer selected from polyesters, polycarbonates, polyamides, polyolefins, polyvinyl acetals, polystyrene, copolymers of styrene or of α-methylstyrene with dienes and/or acrylic derivates, or from halogen-containing polymers, polyisocyanate polyaddition products, and mixtures thereof.

12. The polymer composition according to claim 11, in which the polymer is selected from polyisocyanate polyaddition products and homo- and copolymers of vinyl chloride.

13. A process for preparation of polyisocyanate polyaddition products via the reaction of polyisocyanates with compounds reactive toward isocyanates, wherein the reaction takes place in the presence of a stabilizer composition (S) as defined in claim 1.

14. The process according to claim 13, wherein the reaction also takes place in the presence of at least one antioxidant selected from the group consisting of phosphites, sulfites, phenothiazine, aromatic amines, phenolic antioxidants, benzofuranones, dilauryl 3,3′-thiodipropionate, and mixtures thereof.

15. The process according to claim 13, wherein the reaction also takes place in the presence of at least one other component selected from costabilizers, blowing agents, catalysts, colorants, fillers, mold-release agents, and additives.

16. A method of using a stabilizer composition (S) as defined in claim 1, for the stabilization with respect to exposure to light of polymer compositions which comprise at least one polymer selected from polyesters, polycarbonates, polyamides, polyolefins, polyvinyl acetals, polystyrene, copolymers of styrene or α-methylstyrene with dienes and/or acrylic derivatives, polyisocyanate polyaddition products, halogen-containing polymers, and mixtures thereof.

17. The method according to claim 16, wherein the form in which the polymer composition is present is that of a molding for a means of transport.
